(19) United States
(12) Patent Application Publication
(10) Pub. No.: US 2004/0175557 A1
(43) Pub. Date: Sep. 9, 2004

(54) Reinforcing glass yarns with low dielectric constants

(76) Inventors: Sophie Creux, Delft (FR); Emmanuel Lecomte, Bobigny (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/478,616

(22) PCT Filed: May 2, 2002
(86) PCT No.: PCT/FR02/01509

(30) Foreign Application Priority Data
May 23, 2001 (FR) 01/06859

(51) Int. Cl. B32B 27/02

(52) U.S. Cl. 428/299.7; 428/375

(57) ABSTRACT

Glass reinforcement yarn, the composition of which comprises the following constituents, in the limits defined below, expressed as percentages by weight:

| SiO₂ | 50 to 60%, preferably SiO₂ ≧ 52% and/or |
|---|---|
| | SiO₂ ≦ 57% |
| Al₂O₃ | 10 to 19%, preferably Al₂O₃ ≧ 13% and/or |
| | Al₂O₃ ≦ 17% |
| B₂O₃ | 16 to 25% |
| P₂O₅ | 0.5 to 4% |
| Na₂O | ≦ 1.5%, preferably Na₂O ≦ 0.8% |
| K₂O | ≦ 1.5%, preferably K₂O ≦ 0.8% |
| R₂O | ≦ 2%, preferably R₂O ≦ 1% |
| CaO | ≦ 10% |
| MgO | ≦ 10% |
| F | ≦ 0 to 2% |
| RO | 4 to 15%, preferably RO ≧ 6% and/or |
| | RO ≦ 10% |
| Various | ≦ 3%, |

where R₂O = Na₂O + K₂O + Li₂O, and RO = CaO + MgO.

The dielectric properties of such glass compositions are particularly advantageous.

The present invention relates to glass “reinforcement” yarns (or “fibers”), that is to say those that can be used for the reinforcement of organic and/or inorganic materials and can be used as textile yarns, these yarns being able to be obtained by the process which consists in mechanically drawing streams of molten glass flowing out from orifices located at the base of a bushing generally heated by resistance heating.

The present invention is aimed more particularly at glass yarns of low dielectric constant having a particularly advantageous novel composition.

This is because there is a growing demand for glass yarns whose permittivity and dielectric losses are low, these being mainly used in the form of fabrics, in order to reinforce printed-circuit substrates. The latter consist mainly of a reinforcement, especially glass yarns, and a resin, on which substrates various electrical and/or electronic components are placed.

With, on the one hand, the increase in the speed of processing of electrical and/or electronic signals, which involve signals of ever higher frequency, and, on the other hand, the miniaturization of the components which allows their density on a substrate to be increased, the dielectric properties of this substrate become crucial. If these properties do not have the expected performance, there may be a risk of overheating and/or of signal distortion.

The polymers conventionally used for printed-circuit boards consist essentially of epoxy resin. Polymers having superior dielectric properties are known at the present time, especially polyimide resins, cyanate ethers, polyester or even PTFE, the dielectric properties of which are satisfactory.

Any improvement in the dielectric properties of a printed-circuit board must therefore essentially rely on improving the properties of the reinforcement, namely the glass yarns within the context of the present invention, which occupy in general about 60% of the volume.

A glass subjected to an AC current converts some of the latter into electrical energy dissipated in the material. This electrical energy is known as dielectric loss. The dielectric losses are proportional to the permittivity and to the loss tangent (tan δ) which depend on the composition of the glass for a given frequency. The dielectric losses are expressed as (see for example J. C. Dubois in “Techniques de l'Ingénieur [Engineering Techniques”], heading: “Electronique [Electronics]”, Chapter E 1850: “Propriétés diélectriques des polymères [Dielectric properties of polymers]”):

W=kfv²ε tan δ

where: W is the electrical energy dissipated in the glass or the dielectric loss;

k is a constant;

f is the frequency;

v is a potential gradient;

ε is the permittivity; and

tan δ is the dielectric loss tangent or dielectric dissipation factor.

It is usual to denote ε tan δ as ε″, if tan δ< 0.1.

It is clearly apparent from this formula that the more the frequency increases, or the more ε and/or tan δ increase, the greater the dielectric losses become.

In the rest of the text, the term “dielectric properties” refers to the pair (ε, ε″). To minimize the distortion of a signal, it is desired that both ε and ε″ be as low as possible.

It is therefore important to obtain glass compositions, which are fiberizable in order to form continuous reinforcing yarns, whose dielectric properties are compatible with the requirements of the latest printed circuits.

More specifically, the tendency to increase the operating frequencies of components, with frequency ranges of the order of 1 GHz (gigahertz), especially 0.9 and 1.8 GHz in the case of telephony, should be noted.

It is therefore very important to study the behavior of glass yarns in this frequency range and to optimize their composition so as to limit the dielectric losses, especially for this field of application.

It should be noted that the prior studies published in this field relate to dielectric properties of glasses in a frequency range of the order of 1 MHz (megahertz).

It is therefore an object of the invention to provide novel glass compositions for forming reinforcement yarns whose dielectric properties are of the same order of magnitude as the dielectric properties of the known glasses within the MHz range, which glass compositions have at the same time improved dielectric properties in the GHz range, while still having satisfactory fiberizing properties in order to obtain reinforcement yarns economically.

Furthermore, it is desirable that the glass yarns in question have good hydrolytic resistance properties.

In the rest of the description, the following are defined:

→ in respect of the dielectric properties:

“MHz range” is a frequency range in which the characterization of the dielectric properties of the glasses is carried out, especially at 1 MHz;

“GHZ range” is a frequency range in which the characterization of the dielectric properties of the glasses is carried out, especially at 10 GHz;

it is usually considered that the dielectric properties are satisfactory if ε″ is less than 50×10⁻⁴ for measurements at 1 MHz and less than 100×10⁻⁴ for measurements at 10 GHz.

Furthermore, it is desirable that the value of ε be low, preferably less than 6, or even less than or equal to 5.

→ the fiberizing properties, which are especially determined by:

the temperature corresponding to a viscosity of 10³ poise (decipascal.second), denoted “T(log η=3)”, which gives precious information about the temperature around which the fiberizing is generally carried out, especially from platinum bushings;

the “liquidus temperature”, denoted “T_{liquidus}”, which corresponds to the temperature at which the growth rate of the most refractory crystal is zero. The liquidus temperature gives the upper limit of the temperature range in which the glass may have a tendency to devitrify.

It is considered possible to fiberize the glass economically if T(log η=3) is less than or equal to 1350° C. and if T_{liquidus} is more than 100° C., preferably more than 300° C., below T(log η=3). The greater this difference between T(log η=3) and T_{liquidus}, the more likely the fiberizing will be carried out without any incident, and the more the risks of breakage during fiberizing are minimized.

→ the term “hydrolytic resistance” is understood to mean the capacity that a glass has to dissolve by leaching.

This property is determined by measuring the weight loss of finely ground (between 360 and 400 μm) glass powders after remaining in water maintained at the boiling point for five hours (10 g of glass in 100 ml of water). After rapid cooling, the solution is filtered and part of the filtrate is weighed after evaporation. In this way, the amount of glass extracted (“leached” glass, in mg) per gram of glass tested is determined, this being denoted “DGG”. The lower the value of DGG, the more resistant to hydrolysis the glass is. It is considered that the hydrolytic resistance of a glass is good if the DGG value is less than 25 and excellent if the value is less than 10.

The glass reinforcement yarns most commonly used are thus yarns formed from glasses which derive from the 1170° C. eutectic of the SiO₂—Al₂O₃—CaO ternary diagram, particularly the yarns referred to as E-glass yarns, the archetype of which is described in Patents U.S. Pat. No. 2,334,981 and U.S. Pat. No. 2,571,074. E-glass yarns have a composition essentially based on silica, alumina, lime and boric anhydride. The boric anhydride, present in amounts ranging in practice from 5 to 13% by weight in “E-glass”-type glass compositions, replaces some of the silica. E-glass yarns are furthermore characterized by a limited content of alkali metal oxides (essentially Na₂O and/or K₂O). Their dielectric properties prove to be insufficient regarding the new requirements for printed-circuit substrates.

Another family of glass yarns is known and obtained from compositions very rich in silica and boron. The glasses of this family, known by the name “D-glasses” comprise about 75% of SiO₂, 20% of B₂O₃ and 3% of alkali metals. These glasses are particularly beneficial for their dielectric properties, but they are very difficult to fiberize (T(log η=3)>1400° C.) and are therefore particularly expensive.

Novel families of compositions have recently been proposed which make it possible to obtain useful dielectric properties and achieve relatively economic fiberizing conditions. These compositions are described for example in applications WO 99/39363 and WO 99/52833.

These compositions, although very useful for their dielectric properties measured in the MHz range, exhibit high dielectric losses in the GHz range, as the results given in table I show.

The glass yarns according to the invention are obtained from a composition essentially comprising the following constituents, in the limits defined below, expressed as percentages by weight:

| | |
|---|---|
| SiO₂ | 50 to 60% |
| Al₂O₃ | 10 to 19% |
| B₂O₃ | 16 to 25% |
| P₂O₅ | 0.5 to 4% |
| Na₂O | less than or equal to 1.5% |
| K₂O | less than or equal to 1.5% |
| R₂O (Na₂O + K₂O + Li₂O) | less than or equal to 2% |
| CaO | less than or equal to 10% |
| MgO | less than or equal to 10% |
| RO (CaO + MgO) | 4 to 15% |
| F | 0 to 2% |
| Various | less than or equal to 3%. |

The invention therefore provides a novel family of compositions selected in order to obtain good dielectric properties in the MHz range.

Surprisingly, it has been noted that the compositions according to the invention also exhibit good dielectric properties in the GHz range.

The compositions according to the invention make it possible to obtain satisfactory and advantageous fiberizing properties, allowing economic fiberizing to be carried out, especially because T(log η=3)≦1350° C.

Remarkably, the compositions according to the invention have a very low liquidus temperature, especially less than or equal to 1000° C. As a result, the risk of devitrification during fiberizing in the cold regions of the fiberizing crucible and in the channels conducting the glass from the furnace to the fiberizing crucibles is substantially reduced.

Furthermore, the compositions according to the invention exhibit good hydrolytic resistance, especially with DGG values of less than 10.

Silica is one of the oxides which forms the network of the glasses according to the invention and fulfills the essential role of stabilizing them.

The silica (SiO₂) content of the selected compositions is between 50 and 60%, especially greater than 52%, and/or especially less than or equal to 57%.

The alumina also constitutes a network former of the glasses according to the invention and fulfills a very important role as regards the hydrolytic resistance of these glasses. Within the context of the limits defined according to the invention, reducing the amount of this oxide to below 10% means that the glass is substantially more susceptible to hydrolytic attack, whereas excessively increasing the amount of this oxide entails the risks of devitrification and an increase in the viscosity.

The alumina (Al₂O₃) content of the selected compositions is between 10 and 19%, especially greater than or equal to 13%, and/or especially less than or equal to 17%.

The lime (CaO) content of the selected compositions is less than or equal to 10%, especially less than or equal to 8%, or even less than or equal to 6%, and/or preferably greater than or equal to 2%, or even greater than or equal to 4%.

The magnesia (MgO) content of the selected compositions is less than or equal to 10%, especially less than or equal to 8%, or even less than or equal to 6%, and/or preferably greater than or equal to 2%.

The addition of phosphorus, expressed in P₂O₅ form, appears to be an essential point of the invention. The P₂O₅ is between 0.5 and 4%, preferably greater than or equal to 1% and/or preferably less than or equal to 3%, or even less than or equal to 2%. This oxide appears to play a very important role in the dielectric properties, especially in the GHz range, as the results presented below prove.

The defined limits, in terms of alkaline-earth metal oxides, lime and magnesia, make it possible to adjust the viscosity and control the devitrification of the glasses according to the invention. Good fiberizability is obtained by choosing the sum of these alkaline-earth metal oxides to be between 4 and 15%, preferably greater than or equal to 6% and/or preferably less than or equal to 10%.

Furthermore, CaO appears to make a beneficial contribution to the hydrolytic resistance.

Alkali metal oxides, especially sodium oxide (Na₂O) and potassium oxide (K₂O), may be introduced into the compositions of the glass yarns according to the invention in order to limit devitrification and possibly reduce the viscosity of the glass. However, the content of alkali metal oxides (Na₂O+K₂O+Li₂O) must remain less than or equal to 2% in order to avoid any deterioration in the dielectric properties and to avoid a detrimental reduction in the hydrolytic resistance of the glass. The alkali metal oxide content is generally greater than 0.1%, due to the presence of impurities contained in the batch materials bearing other constituents and it is preferably less than or equal to 1%, or less than 0.5% or even less than 0.3%. The composition may contain a single alkali metal oxide (from Na₂O, K₂O and Li₂O) or may contain a combination of at least two alkali metal oxides, the content of each alkali metal oxide being less than or equal to 1.5%, preferably less than or equal to 0.8%.

The boron content is between 16 and 25%, preferably greater than or equal to 18% and/or preferably less than or equal to 22%, or even less than or equal to 20%. According to a preferred version of the invention, it is desired to limit this oxide to moderate contents as compared with those of D-glass on the one hand, and not to degrade the hydrolytic resistance on the other, since the cost of boron-bearing batch materials is high. Boron may be introduced in a moderate amount by incorporating, as batch material, glass yarn scrap comprising boron, for example E-glass yarn scrap.

To improve the melting of the glass, fluorine (F₂) may be added in a small amount, especially from 0.5 to 2%, or it may be present as an impurity, especially from 0.1 to 0.5%.

The possible TiO₂ and/or Fe₂O₃ contents are rather to be considered as contents of impurities, frequently encountered in this family of compositions. TiO₂ may have a content of up to between 2 and 3%, but it is preferably less than 2% or even less than 1%.

In the rest of the text, any percentage of a constituent of the composition must be understood as a percentage by weight, and the compositions according to the invention may include up to 2 or 3% of compounds to be regarded as unanalyzed impurities, as is known in this kind of composition.

The invention also relates to composites formed from glass yarns and an organic material, in which the reinforcement is provided at least by the glass yarns of compositions defined above.

Preferably, such glass yarns are used for the manufacture of printed-circuit substrates.

The subject of the invention is also a process for manufacturing glass yarns of compositions defined above, in which a multiplicity of molten glass streams, flowing out of a multiplicity of orifices placed at the base of one or more bushings, is drawn in the form of one or more webs of continuous filaments, and then the filaments are gathered together into one or more yarns which are collected on a moving support.

Preferably, the molten glass feeding the orifices of the bushing or bushings has the following composition, expressed as percentages by weight:

| SiO₂ | 50 to 60%, preferably SiO₂ ≧ 52% and/or |
|---|---|
| | SiO₂ ≦ 57% |
| Al₂O₃ | 10 to 19%, preferably Al₂O₃ ≧ 13% and/or |
| | Al₂O₃ ≦ 17% |
| B₂O₃ | 16 to 25% |
| P₂O₅ | 0.5 to 4% |
| Na₂O | ≦ 1.5%, preferably Na₂O ≦ 0.8% |
| K₂O | ≦ 1.5%, preferably K₂O ≦ 0.8% |
| R₂O | ≦ 2%, preferably R₂O ≦ 1% |
| CaO | ≦ 10% |
| MgO | ≦ 10% |
| F | ≦ 0 to 2% |
| RO | 4 to 15%, preferably RO ≧ 6% and/or |
| | RO ≦ 10% |
| Various | ≦ 3%, |

where R₂O = Na₂O + K₂O + Li₂O, and RO = CaO + MgO.

It is thus possible to manufacture such glass yarns under operating conditions similar to those for E-glass and thus to obtain, particularly economically, glasses with good dielectric properties.

The invention also relates to glass compositions suitable for producing glass reinforcement yarns, comprising the following constituents, in the limits defined below, expressed as percentages by weight:

| SiO₂ | 50 to 60%, preferably SiO₂ ≧ 52% and/or |
|---|---|
| | SiO₂ ≦ 57% |
| Al₂O₃ | 10 to 19%, preferably Al₂O₃ ≧ 13% and/or |
| | Al₂O₃ ≦ 17% |
| B₂O₃ | 16 to 25% |
| P₂O₅ | 0.5 to 4% |
| Na₂O | ≦ 1.5%, preferably Na₂O ≦ 0.8% |
| K₂O | ≦ 1.5%, preferably K₂O ≦ 0.8% |
| R₂O | ≦ 2%, preferably R₂O ≦ 1% |
| CaO | ≦ 10% |
| MgO | ≦ 10% |
| F | ≦ 0 to 2% |
| RO | 4 to 15%, preferably RO ≧ 6% and/or |
| | RO ≦ 10% |
| Various | ≦ 3%, |

where R₂O = Na₂O + K₂O + Li₂O, and RO = CaO + MgO.

The advantages afforded by the glass yarns according to the invention will be more fully appreciated through the following examples, denoted Ex. 1 and Ex. 2, given in table I, illustrating the present invention without however limiting it.

Comparative examples, denoted A, B, C, are also given in table I.

In these examples, glass yarns composed of 14 μm diameter glass filaments were obtained by drawing molten glass; the glass had the composition indicated in table I, expressed in percentages by weight.

When the total sum of the contents of all of the compounds is slightly less than or greater than 100%, it should be understood that the residual content corresponds to the impurities and to minor components not analyzed (with contents of at most 1 to 2%) and/or is due to the accepted approximation in this field in the analytical methods used.

T(log η=3) denotes the temperature at which the viscosity of the glass is 10³ poise (décipascal.second).

T_{liquidus} denotes the liquidus temperature of the glass, corresponding to the temperature at which the most refractory phase, which may devitrify in the glass, has a zero growth rate and thus corresponds to the melting point of this devitrified phase.

The values of the dielectric properties (ε, ε″) measured both at 1 MHz and at 10 GHz are indicated.

The measurements at 1 MHz were carried out in a conventional manner, known to a person skilled in the art for this type of metrology.

The measurements at 10 GHz were carried out according to the method described by W. B. Westphal (“Distributed Circuits”, in “Dielectric materials and applications”, the Technology Press of MIT and John Wiley & Sons, Inc. New York, Chapman & Hall, Ltd., London, 1954; see especially page 69). The principle of this method is based on measuring the dielectric properties of a disk-shaped specimen placed against a waveguide.

This method allows accurate results to be obtained at very high frequency.

Also indicated are the measurements of the hydrolytic resistance of the glass, as carried out according to the “DGG” test defined above.

Comparative examples A, B, C correspond respectively to:

A: E-glass

B: D-glass

C: glass according to patent application WO 99/52833.

It may be seen that the examples according to the invention represent a remarkable compromise between fiberizing properties and dielectric properties.

This is because their fiberizing properties are particularly advantageous, especially with a liquidus temperature below 1000° C.

The fiberizing range is very broad, especially with a difference between T(log η=3) and T_{liquidus} of more than 300° C.

The dielectric properties of the compositions according to the invention are of the same of magnitude as those of the compositions according to WO 99/52833 for measurements at 1 MHz.

A surprising effect is observed in the case of the dielectric properties measured at 10 GHz on the glasses according to the invention. This is because the dielectric losses of the glasses according to the invention are about half those of the glasses according to WO 99/52833 and are about one fifth of those obtained on an E-glass.

Thus, dielectric properties remarkably close to those of D-glass are obtained, while considerably lowering the fiberizing temperature of the glasses according to the invention, compared with that of D-glass.

It should also be noted that the glasses according to the invention exhibit excellent hydrolytic resistance.

The glass yarns according to the invention are advantageously suitable for all the usual applications of conventional E-glass yarns and may be substituted for D-glass yarns for some applications.

TABLE I

| | | Ex 1 | Ex 2 | A | B | C |
|---|---|---|---|---|---|---|
| SiO₂ | | 52.4 | 53.0 | 54.4 | 75.3 | 52.7 |
| Al₂O₃ | | 15.8 | 15.8 | 14.5 | 0.7 | 15.9 |
| B₂O₃ | | 19.0 | 19.6 | 7.3 | 19.6 | 18.8 |
| Na₂O | | 0.5 | 0.5 | 0.55 | 1.8 | |
| K₂O | | 0.3 | 0.3 | 0.35 | 1.2 | |
| R₂O | | 0.8 | 0.8 | 0.9 | 3 | 0.8 |
| CaO | | 5.2 | 5.3 | 22.1 | 0.8 | 4.5 |
| MgO | | 3.8 | 3.9 | 0.25 | 0.4 | 4 |
| TiO₂ | | 0.15 | 0.15 | | | 2.8 |
| P₂O₅ | | 2.6 | 1.2 | | | |
| F | | 0.2 | 0.2 | | | 0.3 |
| T (logη = 3) (° C.) | | 1342 | 1327 | 1200 | 1410 | 1305 |
| T_{liquidus} ° C. | | 990 | 960 | 1080 | <900 | 1060 |
| ε at 1 | MHz | 5.1 | 4.9 | 6.6 | 4.6 | 5.2 |
| ε″ at 1 | MHz (× 10⁴) | ≦40 | ≦40 | 80 | 40 | 40 |
| ε at 10 | GHz | 3.4 | 3.4 | 2.6 | 3.0 | 3.6 |
| ε″ at 10 | GHz (× 10⁴) | 90 | 90 | 600 | 30 | 170 |

| | | | | | |
|---|---|---|---|---|---|
| DGG | 5.8 | <6 | 7 | 40 | 5.8 |

1. A glass reinforcement yarn, the composition of which comprises the following constituents, in the limits defined below, expressed as percentages by weight:

| SiO₂ | 50 to 60%, preferably SiO₂ ≧ 52% and/or |
|---|---|
| | SiO₂ ≦ 57% |
| Al₂O₃ | 10 to 19%, preferably Al₂O₃ ≧ 13% and/or |
| | Al₂O₃ ≦ 17% |
| B₂O₃ | 16 to 25% |
| P₂O₅ | 0.5 to 4% |
| Na₂O | ≦1.5%, preferably Na₂O ≦ 0.8% |
| K₂O | ≦1.5%, preferably K₂O ≦ 0.8% |
| R₂O | ≦2%, preferably R₂O ≦ 1% |
| CaO | ≦10% |
| MgO | ≦10% |
| F | ≦0 to 2% |
| RO | 4 to 15%, preferably RO ≧ 6% and/or |
| | RO ≦ 10% |
| Various | ≦3%, |

where R₂O = Na₂O + K₂O + Li₂O, and RO = CaO + MgO.

2. The glass yarn as claimed in claim 1, characterized in that the composition has a phosphorus (P₂O₅) content such that P₂O₅≧1% and/or P₂O₅≦3% or even P₂O₅≦2%.

3. The glass yarn as claimed in one of the preceding claims, characterized in that the composition has a lime (CaO) content such that CaO≦8%, or even CaO≦6% and/or CaO≧2%, or even CaO≧4%.

4. The glass yarn as claimed in one of the preceding claims, characterized in that the composition has a magnesia (MgO) content such that MgO≦8%, or even MgO≦6% and/or MgO≧2%.

5. The glass yarn as claimed in one of the preceding claims, characterized in that the composition has a boron (B₂O₃) content such that B₂O₃≧18% and/or B₂O₃≦22%, or even B₂O₃≦20%.

6. A composite of glass yarns and organic and/or inorganic material(s), characterized in that it comprises glass yarns as defined by one of claims 1 to 5.

7. Use of the glass yarns defined by one of claims 1 to 5 for the manufacture of printed-circuit substrates.

8. A process for manufacturing glass yarns as defined in one of claims 1 to 5, in which a multiplicity of molten glass streams, flowing out of a multiplicity of orifices located at the base of one or more bushings, is drawn in the form of one or more webs of continuous yarns and then the filaments are gathered together into one or more yarns which are collected on a moving support.

9. The process as claimed in claim 8, characterized in that the molten glass feeding the orifices of the bushing or bushings has the following composition, expressed as percentages by weight:

| SiO₂ | 50 to 60%, preferably SiO₂ ≧ 52% and/or |
|---|---|
| | SiO₂ ≦ 57% |
| Al₂O₃ | 10 to 19%, preferably Al₂O₃ ≧ 13% and/or |
| | Al₂O₃ ≦ 17% |
| B₂O₃ | 16 to 25% |
| P₂O₅ | 0.5 to 4% |
| Na₂O | ≦ 1.5%, preferably Na₂O ≦ 0.8% |
| K₂O | ≦ 1.5%, preferably K₂O ≦ 0.8% |
| R₂O | ≦ 2%, preferably R₂O ≦ 1% |
| CaO | ≦ 10% |
| MgO | ≦ 10% |
| F | ≦ 0 to 2% |
| RO | 4 to 15%, preferably RO ≧ 6% and/or |
| | RO ≦ 10% |
| Various | ≦ 3%, |

where R₂O = Na₂O + K₂O + Li₂O, and RO = CaO + MgO.

10. A glass composition suitable for producing glass reinforcement yarns, comprising the following constituents, in the limits defined below, expressed as percentages by weight:

| SiO₂ | 50 to 60%, preferably SiO₂ ≧ 52% and/or |
|---|---|
| | SiO₂ ≦ 57% |
| Al₂O₃ | 10 to 19%, preferably Al₂O₃ ≧ 13% and/or |
| | Al₂O₃ ≦ 17% |
| B₂O₃ | 16 to 25% |
| P₂O₅ | 0.5 to 4% |
| Na₂O | ≦ 1.5%, preferably Na₂O ≦ 0.8% |
| K₂O | ≦ 1.5%, preferably K₂O ≦ 0.8% |
| R₂O | ≦ 2%, preferably R₂O ≦ 1% |
| CaO | ≦ 10% |
| MgO | ≦ 10% |
| F | ≦ 0 to 2% |
| RO | 4 to 15%, preferably RO ≧ 6% and/or |
| | RO ≦ 10% |
| Various | ≦ 3%, |

where R₂O = Na₂O + K₂O + Li₂O, and RO = CaO + MgO.
